(19) United States
(12) Patent Application Publication
(10) Pub. No.: US 2026/0186825 A1
(43) Pub. Date: Jul. 2, 2026

(54) SYSTEM AND METHOD FOR NO-CODE WORKFLOW

(71) Applicant: CCH Incorporated, Riverwoods, IL (US)

(72) Inventors: Bernard Hirsch, Dallas, TX (US); Shahbaz Khan, Ontario (CA); Harry Sabnani, Township of Washington, NJ (US); Amar Pratap Rama Murthy, Sugarland, TX (US); Adam Orentlicher, Apex, NC (US); Mark McAndrew, Watertown, MA (US)

(21) Appl. No.: 19/006,352

(22) Filed: Dec. 31, 2024

(51) Int. Cl. G06F 9/48; G06F 9/451; G06F 9/54

(52) U.S. Cl. CPC G06F 9/4843; G06F 9/452; G06F 9/543

(57) ABSTRACT

System and methods for no-code or low-code workflow generation are disclosed. A user interface is generated to receive a set of workflow instructions associated with a workflow and the set of workflow instructions received. The set of workflow instructions is parsed using one or more models to identify and extract a plurality of tasks associated with the workflow. For each task of the plurality of tasks, the task is executed using a plurality of application programming interfaces. Each of the application program interfaces exchanges metadata between each other and the metadata is associated with one or more tasks of the plurality of tasks.

### TECHNICAL FIELD

This application relates generally to workflows and, more particularly, to systems and methods for analyzing contextual data of a user interface to generate no-code or low-code workflows.

### BACKGROUND

Workflows are currently used by companies and businesses to ensure tasks are completed efficiently. Building and maintaining of traditional and conventional workflows often require knowledge and proficiency in programming languages and use of specific coding tools. This can limit a user form creating, editing, or using a workflow to assist with accomplishing tasks and also hindering their ability to automate tasks and optimize processes.

Further, the development of traditional workflows can be time-consuming and expensive, requiring dedicated programming resources or the purchase of specialized software. This can be a significant hurdle for businesses and individuals with limited resources. Traditional workflows may also be inflexible and not easily customizable without significant coding modifications to adapt to changing desires of the user.

### SUMMARY

The embodiments described herein are directed to systems and method for no-code workflow.

In various embodiments, a system including a computing device comprising at least one processor in communication with a database. The computing device generates a user interface to receive a set of workflow instructions associated with a workflow, receives the set of workflow instructions, parses the set of workflow instructions using one or more models to identify and extract a plurality of tasks associated with the workflow, and, for each task of the plurality of tasks, executes the task using a plurality of application programming interfaces. Each of the application program interfaces exchanges metadata between each other. The metadata is associated with one or more tasks of the plurality of tasks.

In some embodiments, the user interface enables a user to input the set of workflow instructions by dragging and dropping the plurality of tasks on a display screen of the user interface. A first application programming interface of the plurality of application programming interfaces transmits metadata to a second application programming interface of the plurality of application programming interfaces, the metadata being associated with a task of the workflow.

In some embodiments, the computing device, upon execution of the plurality of tasks, generates execution data associated with the execution of the plurality of tasks.

In some embodiments, the computing device publishes the workflow to allow access to a plurality of users, wherein the workflow is stored within a historical database.

In some embodiments, the computing device presents, on the user interface, the plurality of tasks in an ordered manner.

In some embodiments, the plurality of tasks includes an initial task and completion of the initial tasks results in execution of the workflow.

In some embodiments, the plurality of tasks includes an initial task, a first task, and a second task, and execution of the first task occurs upon completion of the initial task, and execution of the second task occurs upon execution of the first task.

In some embodiments, the plurality of task may be re-ordered based on a user rearranging the plurality of tasks by dragging and dropping one or more tasks of the plurality of tasks.

In some embodiments, the computing device identifies, within a database, one or more template workflows for execution based on the set of workflow instructions, the one or more template workflows being substantially similar to the workflow.

In various embodiments, a computer-implemented method is disclosed. The computer-implemented method includes: generating a user interface to receive a set of workflow instructions associated with a workflow, receiving the set of workflow instructions, parsing the set of workflow instructions using one or more models to identify and extract a plurality of tasks associated with the workflow, and, for each task of the plurality of tasks, executing the task using a plurality of application programming interfaces, wherein each of the application program interfaces exchanges metadata between each other, the metadata associated with one or more tasks of the plurality of task.

In some embodiments a user inputs the set of workflow instructions by dragging and dropping the plurality of tasks on a display screen of the user interface. A first application programming interface plurality of application programming interfaces transmits metadata to a second application programming interface of plurality of application programming interfaces, the metadata being associated with a task of the workflow.

In some embodiments, the method further include, s upon execution of the plurality of tasks, generating execution data associated with the execution of the plurality of tasks.

In some embodiments, the method further includes publishing the workflow to allow access to a plurality of users, wherein the workflow is stored within a historical database.

In some embodiments, the method further includes presenting, on the user interface, the plurality of tasks in an ordered manner.

In some embodiments, the plurality of tasks includes an initial task and completion of the initial tasks results in execution of the workflow.

In some embodiments, the plurality of tasks includes an initial task, a first task, and a second task, and execution of the first task occurs upon completion of the initial task, and execution of the second task occurs upon execution of the first task.

In some embodiments, the method further includes identifying, within a database, one or more template workflows for execution based on the set of workflow instructions, the one or more template workflows being substantially similar to the workflow.

In various embodiments, a non-transitory computer readable medium having instructions stored thereon is disclosed. The instructions, when executed by at least one processor, cause at least one device to perform operations including: generating a user interface that receives a set of workflow instructions associated with a workflow, receiving the set of workflow instructions, parsing the set of workflow instructions using one or more models to identify and extract a plurality of tasks associated with the workflow, and, for each task of the plurality of tasks, executing the task using a plurality of application programming interfaces, wherein each of the application program interfaces exchanges metadata between each other, the metadata associated with one or more tasks of the plurality of task.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1A illustrates a block diagram of a flow manager, in accordance with some embodiments;

FIG. 1B illustrates a portion of the block diagram of the flow manager of FIG. 1, in accordance with some embodiments;

FIG. 2 illustrates a network environment that analyzes contextual data of a user interface, in accordance with some embodiments;

FIG. 3 is a flow diagram of a system for no-code or low-code workflow, in accordance with some embodiments;

FIG. 4 is a flow diagram of a system for no-code or low-code workflow, in accordance with some embodiments;

FIG. 5 is a flow diagram of a user interface of the system for no-code or low-code workflow for creating and editing workflows, in accordance with some embodiments;

FIG. 6 is a flow diagram of a user interface of the system for no-code or low-code workflow for executing workflows, in accordance with some embodiments;

FIG. 7 is a flow diagram of a user interface of the system for no-code or low-code workflow for executing workflows, in accordance with some embodiments;

FIG. 8A illustrates a user interface of the system for no-code or low-code workflow for executing workflows, in accordance with some embodiments;

FIG. 8B illustrates a user interface of the system for no-code or low-code workflow for executing workflows, in accordance with some embodiments;

FIG. 8C illustrates a user interface of the system for no-code or low-code workflow for executing workflows, in accordance with some embodiments; and

FIG. 9 is a flowchart illustrating an exemplary method for no-code or low-code workflow, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for no-code and/or low-code workflow. In some embodiments, the systems and methods utilize a flow manager to communicate with one or more databases and application programming interfaces (APIs). For example, the systems and method provided herein may include a flow manager that communicates with one or more APIs to execute one or more tasks. In some embodiments, a user may interact with an interface to provide instructions to the flow manager without providing any code.

In some embodiments, the system includes a user interface that receives workflow instructions from a user. For example, a user may create a set of workflow instructions that is received by the flow manager. The set of instructions may require no coding or programming by the user. In some embodiments, the user uses the user interface to drag-and-drop one or more tasks in a sequential order to create a set of workflow instructions. Based on the set of workflow instructions, the flow manager may sequentially communicate with one or more APIs to execute the set of workflow instructions. In some embodiments, the user interface may allow a user to complete or modify template code to provide a “low-code” input that requires minimal programming understanding or experience to complete.

In some embodiments, the set of workflow instructions includes a plurality of tasks. Each of the plurality tasks may be executable by a different application. For example, a set of workflow instructions may include three tasks (e.g., task one, task two, and task three). A first application may be required to execute task one, a second application may be required to execute task two, and a third application may be required to execute task three. In some embodiments, a flow manager is utilized to communicate with each of the first application, the second application, and the third application via a plurality of APIs.

In some embodiments, the set of workflow instructions includes an initial task. Execution of the initial task may cause the flow manager to initiate and begin executing the next sequential tasks in the set of workflow instructions. For example, execution (or completion) of the initial tasks may cause the workflow to begin and thus cause flow manager to begin sequentially communication with one or more APIs.

In some embodiments, the present disclosure is not limited to no-code and can include limited code workflow generation. For example, in some embodiments, a user may select a workflow task that requires limited code completion. The limited code completion may be provided in the form of template completion, field filling, or other prompts requiring no or minimal code experience to complete.

Furthermore, in the following, various embodiments are described with respect to methods and systems for no-code and/or low-code workflows. In some embodiments, a disclosed method includes generating a user interface that receives a set of code workflow instructions associated with a workflow, receiving the set of workflow instructions, parsing the set of workflow instructions using one or more models to identify and extract a plurality of tasks associated with the workflow, and for each task of the plurality of tasks, executing the task using a plurality of application programming interfaces, wherein each of the application program interfaces exchanges metadata between each other, the metadata associated with one or more tasks of the plurality of tasks.

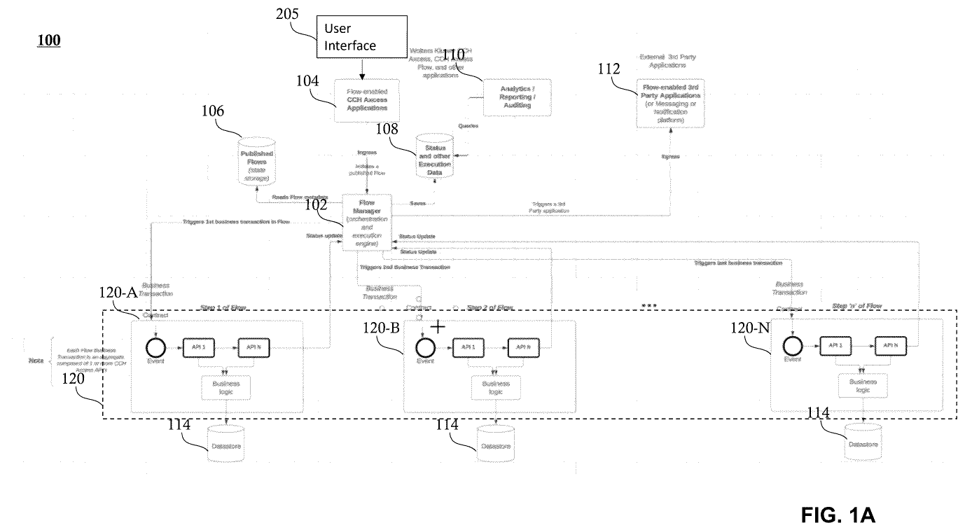

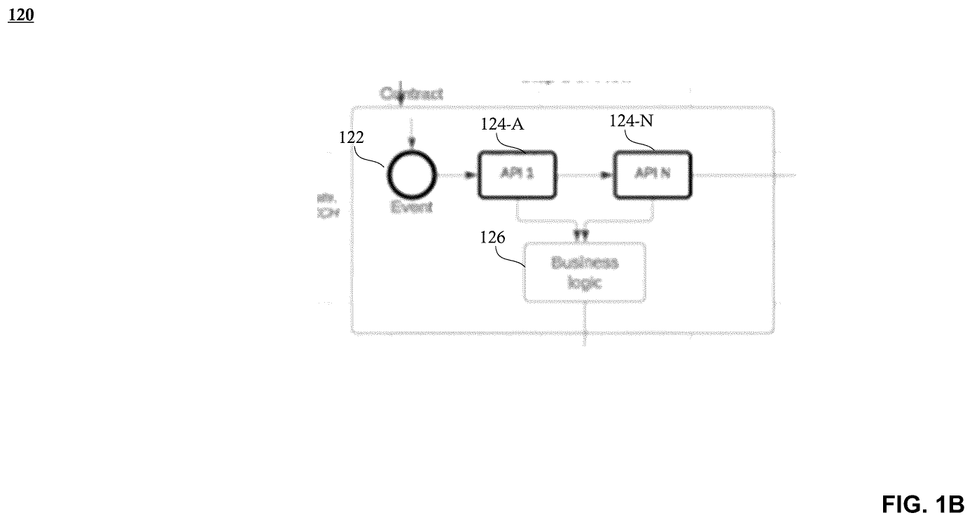

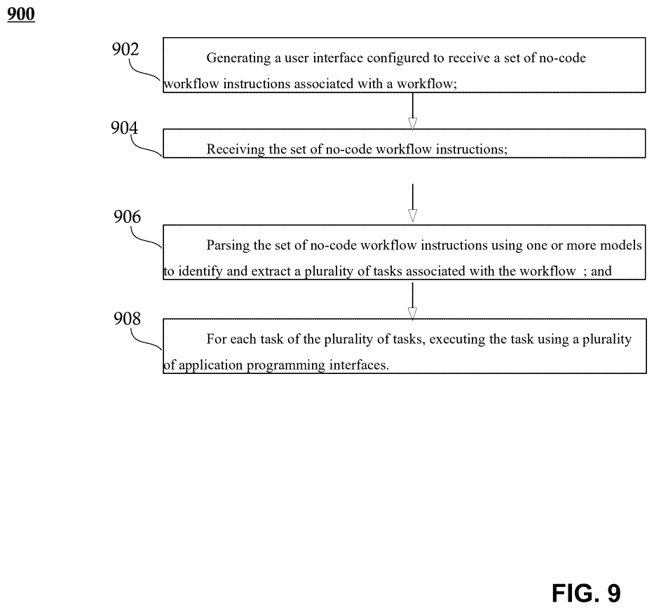

Referring to FIGS. 1A-1B, the present disclosure is directed to a system 100 for no-code and/or low-code workflow. System 100 may include flow manager 102 that communicates with one or more components of system 100. Flow manager 102 may receive data from application 104. In some embodiments, a user interacts with application 104 via user interface 205. Application 104 may be interacted with via user interface 205 and a user may create a set of workflow instructions (e.g., FIGS. 9A-9C) using application 104. For example, a user may interact with application 104 via user interface 205 to drag-and-drop a plurality of tasks in a sequential order. In some embodiments, a user interacts with application 104 via user interface 205 to create one or more tasks. The one or more created tasks may be combined with existing (e.g., published) tasks to generate a set of workflow instructions. In some embodiments, a user interactions with the application 104 via the user interface 205 to provide code completion or edits for limited code instructions.

In some embodiments, flow manager 102 receives the set of workflow instructions prepared by the user and compares the set of workflow instructions to historical workflow instructions stored in historical database 106. For example, flow manager 102 may receive a set of workflow instructions associated with a specific task and compare the set of workflow instructions to historical workflow instructions to identify historical workflow instructions associated with the specific task, enabling flow manager 102 to quickly and efficiently determine which APIs to communicate with. In some embodiments, flow manager 102 is unable to identify historical workflow instructions that are associated with the specific task. In these instances, flow manager 102 generates new instructions to communicate with the APIs based on the set of workflow instructions.

In some embodiments, flow manager 102 receives a set of workflow instructions and generates a status of the set of workflow instructions. Flow manager 102 may transmit a generate status to execution database 108. In some embodiments, execution database 108 receives queries from analytics module 110. For example, flow manager 102 may receive one or more status updates from one or more flow modules 120-A, 120-B, 120-N, and may transmit the one or more status updates to execution database 108. The one or more status updates may indicate whether a task has been completed, initiated, cancelled, modified, published (e.g., saved to historical database 106), or deleted (e.g., removed from one or more databases). In some embodiments, execution database 108 receives one or more queries from analytics module 110. Analytics module 110 may analyze the one or more updates stored within execution database 108. Analytics module 110 may perform an audit of system 100 to determine performance, efficiency, and/or accuracy of tasks performed by flow manager 102. Analytics module 110 may query execution database 108 to determine statuses or updates of one or more tasks initiated, completed, cancelled, etc. by flow manager 102. Analytics module 110 may generate a performance quantification to determine whether modifications need to be made to flow manager 102. Analytics module 110 may also provide reporting or auditing of flow manger 102 to provide statistics of the user of system 100. For example, analytics module 110 may generate statistics including percentages of completed tasks, modified tasks, cancelled tasks, published tasks, or other statistics associate with use of system 100.

In some embodiments, flow manager 102 communicates (e.g., output/transmit data) with third party application 112. Third party application 112 may be an application or API external to system 100. In some embodiments, third party application 112 is a messaging or notification platform. Third party application 112 may be any application, API, or platform that communicates with flow manager 102. In practice, flow manager 102 may send data to third party application 112 based on one or more tasks in a received set of workflow instructions. For example, a set of workflow instructions may include a task of transmitting a message to a third party to indicate completion of a task. Flow manager 102 may transmit messaging data to third party application 112, which may be a messaging service, causing third party application 112 to transmit a message using the messaging service to another individual or computing device.

In some embodiments, flow manager 102 executes a plurality of tasks based on a set of workflow instructions. Flow manager 102 may execute the plurality of tasks without the requirement of a user providing coding or programming and/or may require minimal coding or programming input (e.g., template completion, code snippet selection). Flow manager 102 may communicate with one or more flow modules 120 to execute a task. In some embodiments, flow module 120 includes a plurality of flow modules 120-A, 120-B, 120-N, that each execute a task of the set of workflow instructions.

Flow manager 102 may parse the set of workflow instructions to determine a sequential order of tasks to be executed. For example, flow manager 102 may generate a plurality of sequential tasks (e.g., first task, second task, third task) based on the set of workflow instructions. In some embodiments, each subsequent task is initiated based on execution of a previous task by flow manager 102. For example, flow manager 102 may be triggered to initiate upon completion of an initial task. In some embodiments, flow manager 102 parses the set of workflow instructions using one or more models (e.g., a natural language processing model) to identify and extract keywords. For example, flow manager 102 may parse a set of workflow instructions and extract keywords associating with creating a specific type of document or sending an electronic message.

Flow manager 102 may determine an initial task from the sequential order of tasks (e.g., receive trigger data that the initial task has been completed). Upon execution of the initial task, flow manager 102 may communicate with flow modules 120 to execute the plurality of tasks associated with the set of workflow instructions. For example, flow manager 102 may transmit transaction data to first flow module 120-A indicative of the first task to be executed by flow manager 102 from the set of workflow instructions. Flow module 120 may include a plurality of flow modules (120-A, 120-B, 120-N). For example, flow module 120 may include an N number of flow modules to execute an N number of tasks associated with the set of workflow instructions.

Each flow module 120 may include event trigger 122, one or more APIs 124, and logic module 126. Flow module 120 may utilize APIs 124 to execute a task of the set of workflow instructions. For example, flow manager 102 may receive data associated with a set of workflow instructions from user interface 205 via application 104. Application 104 may be an application or API that communicates with flow manager 102. In some embodiments, flow manager 102 transmits transaction data to flow module 120 to execute a task. Flow module 120 may receive the transaction data resulting in event trigger 122. Event trigger 122 may be trigger or activated upon receipt of transaction data from flow manager 102. Event trigger 122 may cause one or more APIs 124 to communicate with logic module 126 to execute the task associated with the transaction data transmitted to flow module 120.

In some embodiments, each flow module 120 includes a plurality of APIs 124. For example, each flow module 120 may include an N number of APIs. Each API 124 may communicate with logic module 126 to execute the desired task. Logic module 126 may include a set of rules based on the desired task. In some embodiments, each API 124 (e.g., API 124-A, 124-B, 124-N) passes metadata between each other to execute the desired task. Upon execution of the desired task, flow module 120 may transmit status data to flow manager 102 to indicate that the desired task has been completed. Upon receipt of the status data, flow manager 102 may execute a subsequent task using another flow module 120.

By way of an example, a set of workflow instructions may include an initial task, a first task, a second task, and a third task. Flow manger 102 may receive instruction data associated with the set of workflow instructions and parse the instruction data to determine each of the initial task, a first task, a second task, and a third task. Flow manager 102 may receive an indication that the initial task has been executed resulting in flow manager 102 initiating execution of the first task. Flow manager 102 may transmit transaction data to first flow module 120-A, which may execute the first task using a plurality of APIs (e.g., APIs 124-A, 124-B, 124-N). Flow module 120-A may transmit a status to flow manager 102 upon execution of the first task to indicate that the first task has been executed and/or is completed. Flow manager 102 may then initiate execution of the second task. Flow manager 102 may transmit transaction data to second flow module 120-B, which may execute the first task using a plurality of APIs (e.g., APIs 124-A, 124-B, 124-N). Flow module 120-B may transmit a status to flow manager 102 upon execution of the second task to indicate that the second task has been executed and/or is completed. Flow manager 102 may then initiate execution of the third task. Flow manager 102 may transmit transaction data to third flow module 120-C, which may execute the third task using a plurality of APIs (e.g., APIs 124-A, 124-B, 124-N). Flow module 120-C may transmit a status to flow manager 102 upon execution of the third task to indicate that the third task has been executed and/or is completed.

In some embodiments, each flow module 120 transmits data and/or metadata associated with the execution of the task to database 114. Database 114 may store metadata associated with execution of the task. In some embodiments, database 114 is in communication with historical database 106. In alternative embodiments, database 114 is the same database as historical database 106.

In some embodiments, flow manager 102 analyzes and parses the set of workflow instructions and compares the set to published workflow sets stored in historical database 106. Flow manager 102 may receive metadata associated with the published workflow that is identical or substantially similar to the workflow associated with the set of workflow instructions. In some embodiments, the flow manager 102 restricts naming of workflow instructions to prevent overwriting of previously generated sets of workflow instructions.

In some embodiments, each flow module 120 includes a plurality of APIs 124. System 100 may validate each API 124 and the associations between them to allow communication between each API 124 and within system 100.

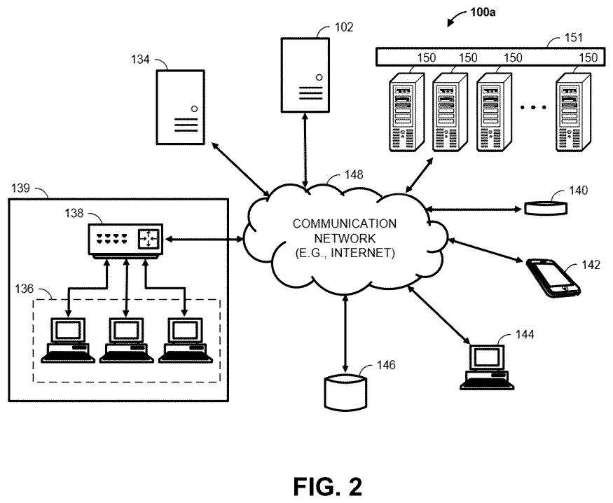

FIG. 2 illustrates a network environment 100a that generates no-code and/or low-code workflows, in accordance with some embodiments. The network environment 100a includes a plurality of devices or systems that communicate over one or more network channels, illustrated as a network cloud 138. For example, in various embodiments, the network environment 100a can include, but not limited to, flow manager 102 (e.g., a server, such as an application server), a web server 134, a cloud-based engine 151 including one or more processing devices 150, workstation(s) 136, a database 146, and one or more user computing devices 140, 142, 144 operatively coupled over the network 138. Flow manager 102, the web server 134, the workstation(s) 136, the processing device(s) 140, and the multiple user computing devices 140, 142, 144 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 148.

In some examples, each of flow manager 102 and the processing device(s) 150 can be a computer, a workstation, a laptop, a server such as a cloud-based server, or any other suitable device. In some examples, each of the processing devices 150 is a server that includes one or more processing units, such as one or more graphical processing units (GPUs), one or more central processing units (CPUs), and/or one or more processing cores. Each processing device 150 may, in some examples, execute one or more virtual machines. In some examples, processing resources (e.g., capabilities) of the one or more processing devices 150 are offered as a cloud-based service (e.g., cloud computing). For example, the cloud-based engine 150 may offer computing and storage resources of the one or more processing devices 150 to flow manager 102.

In some examples, each of the multiple user computing devices 140, 142, 144 can be a cellular phone, a smart phone, a tablet, a personal assistant device, a voice assistant device, a digital assistant, a laptop, a computer, or any other suitable device. In some examples, the web server 134 hosts one or more retailer websites providing one or more products or services. In some examples, flow manager 102, the processing devices 150, and/or the web server 134 are operated by a user or business. The multiple user computing devices 140, 142, 144 may be operated by users interacting with a platform of a business, such as a tax or accounting firm. In some examples, the processing devices 150 are operated by a third party (e.g., a cloud-computing provider).

The workstation(s) 136 are operably coupled to the communication network 148 via a router (or switch) 108. The workstation(s) 136 and/or the router 108 may be located at a store 109 of a retailer, for example. The workstation(s) 136 can communicate with flow manager 102 over the communication network 148. The workstation(s) 136 may send data to, and receive data from, flow manager 102.

Although FIG. 1 illustrates three user computing devices 140, 142, 144, the network environment or system 100 can include any number of user computing devices 140, 142, 144. Similarly, the network environment 100 can include any number of flow manager 102, the processing devices 150, the workstations 136, the web servers 134, and the databases 146. Database 146 may be the same as database 114 and/or historical database 106. In some embodiments, database 146 is in communication with database 114 and/or historical database 106

The communication network 148 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 148 can provide access to, for example, the Internet.

In some embodiments, each of the user computing devices 140, 142, 144 may communicate with the web server 134 over the communication network 148. For example, each of the multiple computing devices 140, 142, 144 may be operable to view, access, and interact with a website, such as a retailer's website hosted by the web server 134. The web server 134 may transmit user session data related to a customer's activity (e.g., interactions) on the website.

In some examples, a customer may operate one of the user computing devices 140, 142, 144 to initiate an application that allows a user to generate a set of workflow instructions. The customer may, via the application, view a user interface for viewing and interacting with the application. Flow manager 102 may allow a user to create instructions, drag-and-drop instructions, or edit instructions to create a sequential list of workflow instructions. In some embodiments, the application captures these activities as user session data, and transmits the user session data to flow manager 102 over the communication network 148. Flow manager 102 may store the user session data within historical database 106.

In some examples, flow manager 102 may execute one or more models (e.g., algorithms), such as a mathematical model, machine learning model, deep learning model, statistical model, predictive model, etc., to predict subsequent tasks in a set of workflow instructions. The output may be presented on the user interface and/or may include a predicted task.

Flow manager 102 is further operable to communicate with the database 146 over the communication network 148. For example, flow manager 102 can store data to, and read data from, the database 146. The database 146 can be a remote storage device, such as a cloud-based server, a disk (e.g., a hard disk), a memory device on another application server, a networked computer, or any other suitable remote storage. Although shown remote to flow manager 102, in some examples, the database 146 can be a local storage device, such as a hard drive, a non-volatile memory, or a USB stick. Database 146 may be coupled to a computing device. For example, database 146 may be coupled to one or more user computing devices 140, 142, 144 via communication network 148.

In some embodiments, outputs from flow manager 102 are used to refine and train one or more models. For example, one or more models may be trained using historical workflow instructions to generate one or more tasks that the user may desire to have executed. Flow manager 102 may receive an indication of whether the user proceeded with the predicted task based on the execution of the task (e.g., execution data), modified the predicted task, or removed the predicted task from the set of workflow instructions. The execution data may be inputted into the one or more models such that the one or more models compares the execution data to the predicted task to generate a comparison value. The greater the comparison value the greater the deviation the predicted task is from what the user desired. In other words, the greater the comparison value, the less accurate the one or more models are. In some embodiments, the comparison value may be inputted into the one or more models to refine the one or more models to make the one or more models more accurate.

The models, when executed by flow manager 102, allow flow manager 102 to generate one or more predicted tasks. In some embodiments, the one or more models may be used to predict a subsequent task based on the one or more initial tasks. In some examples, flow manager 102 assigns the models (or parts thereof) for execution to one or more processing devices 150. For example, each model may be assigned to a virtual machine hosted by a processing device 150. The virtual machine may cause the models or parts thereof to execute on one or more processing units such as GPUs. In some examples, the virtual machines assign each model (or part thereof) among a plurality of processing units. Based on the output of the models, flow manager 102 may perform one or more tasks.

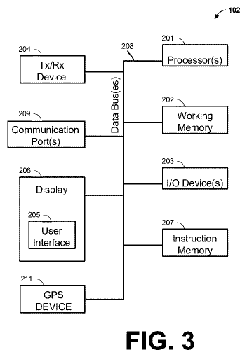

FIG. 3 illustrates a block diagram of a workflow module e.g., the flow manager 102 of FIGS. 1A-1B, in accordance with some embodiments. In some embodiments, each of flow manager 102, the web server 134, the multiple user computing devices 140, 142, 144, and the one or more processing devices 150 in FIG. 2 may include the features shown in FIG. 3. Although FIG. 3 is described with respect to certain components shown therein, it will be appreciated that the elements of flow manager 102 can be combined, omitted, and/or replicated. In addition, it will be appreciated that additional elements other than those illustrated in FIG. 2 can be added to flow manager 102.

As shown in FIG. 3, flow manager 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of flow manager 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 perform a certain function or operation by executing code, stored on the instruction memory 207, embodying the function or operation. For example, the one or more processors 201 may execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that flow manager 102 can include a single memory unit that operates as both instruction memory and working memory. Further, although embodiments are discussed herein including non-volatile memory, it will be appreciated that computing device 140, 142, 144 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, . NET, HTML, CSS, SQL, NoSQL, Rust, Perl, etc. In some embodiments a compiler or interpreter converts the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 148 of FIG. 2. For example, if the communication network 148 of FIG. 2 is a cellular network, the transceiver 204 allows communications with the cellular network. In some embodiments, the transceiver 204 is selected based on the type of the communication network 148 flow manager 102 will be operating in. The one or more processors 201 are operable to receive data from, or send data to, a network, such as the communication network 148 of FIG. 2, via the transceiver 204.

The communication port(s) 209 may include any suitable hardware, software, and/or combination of hardware and software that is capable of coupling flow manager 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 couple flow manager 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with flow manager 102 and/or the web server 134. For example, the user interface 205 can be a user interface for an application of a network environment operator that allows a customer to create a set of workflow instructions. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, flow manager 102 may determine a local geographical area (e.g., town, city, state, etc.) of its position.

In some embodiments, flow manager 102 implements one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 146) that stores relevant training data to train and/or retrain the one or more models used by flow manager 102. The model training system includes one or more model training servers or managers, which are implemented through one or more computing systems, servers, computers, processor and/or other such systems communicatively coupled with one or more of the distributed communication networks 118, and build and/or train the machine learning models. In some implementations, the model training system includes multiple sub-model training systems each associated with one or more of the different machine learning models.

The training data database stores and updates relevant training data. The training data may include historical data of customers. Further, the training data includes historic sales data (e.g., of the recommended products), typically for one or more years, in association with historic inventory information, historic marketing information, and other such information. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems receive feedback information at least through the graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained models to provide more accurate recommended products and prioritization of the recommended products to the customer. This allows the models to be refined per customer to provide recommended products that the customer has a high likelihood of purchasing.

The training data databases (e.g., database 146) can be local to the model training system, remote and accessible over one or more of the communication networks 148 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system receives feedback information through the graphical user interface corresponding to actions by the recipient interfacing with the graphical user interface.

The above and below description includes descriptions of embodiments implementing and/or utilizing trained machine learning models and/or neural networks. For example, the systems and methods described herein may utilize one or more predictive models. In some embodiments, the neural network, machine learning models and/or machine learning algorithms may include, but are not limited to, Large Language Models (LLM), Heuristics, Univariate based techniques, Multivariate, control limit, isolation forest and LOF—ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

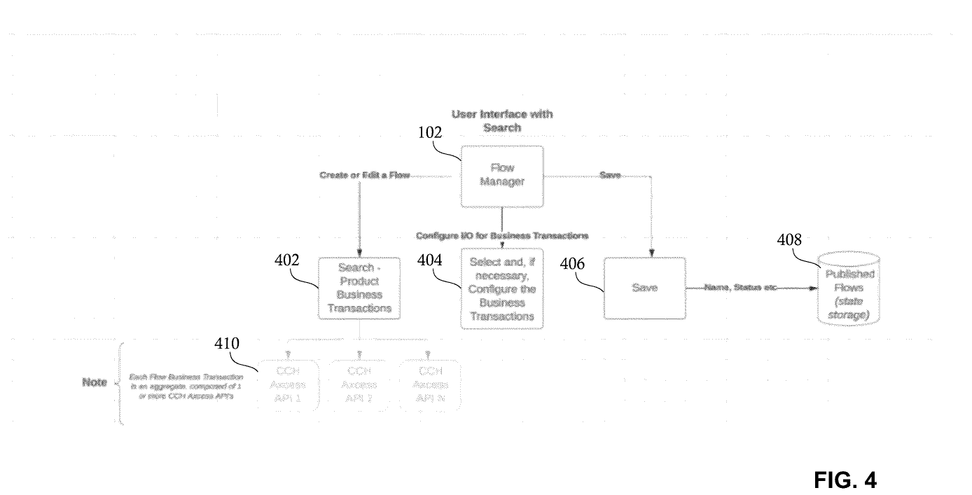

FIG. 4 is a flow diagram showing an exemplary method of using flow manager 102, in accordance with some embodiments. In some embodiments, flow manager 102 creates and/or edits workflows (e.g., a series of tasks) based on a user's input of a set of workflow instructions. As shown in step 402, flow manager 102 may create and/or edit workflows by searching for one or more desired transaction(s) to add to the flow. This may include engaging with one or more APIs 410. At step 404, flow manager 102 may configure inputs and outputs for various transactions (e.g., workflows). For example, flow manager 102 may select and/or configure workflows based on the set of workflow instructions. In some embodiments, the flow manager 102 aligns an output (e.g., one or more parameters of an output) of an identified transaction with an input (e.g., one or more parameters of an input) of an adjacent or next transaction. In some embodiments, the flow manager 102 may receive limited input from a user for code completion and/or limited code modifications for alignment of one or more inputs and outputs. At step 406, flow manager 102 may save one or more generated workflows. Flow manager 102 may save the one or more generated workflows (generated based on a set of workflow instructions) and save the generated workflows within published flow database 408. Published flow database 408 may be the same as historical database 106 or in communication with historical database 106.

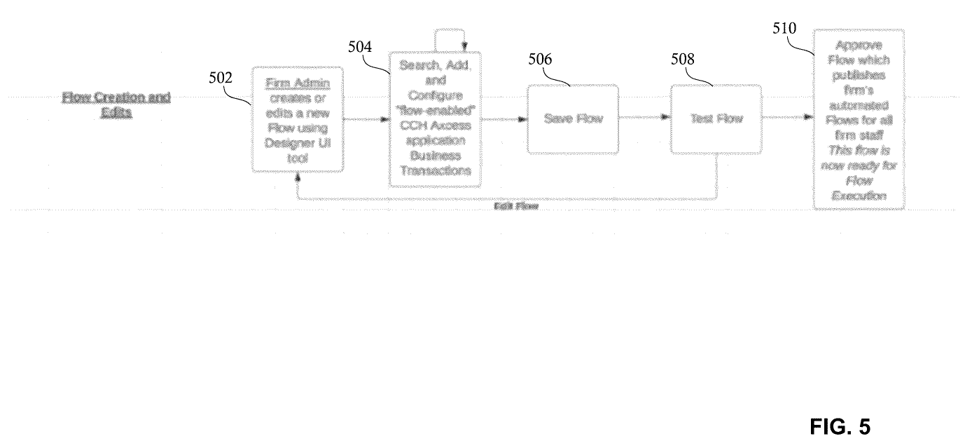

FIG. 5 is a flow diagram showing an exemplary method of using flow manager 102, in accordance with some embodiments. In some embodiments, flow manager 102 creates and/or edits workflows (e.g., a series of tasks) based on a user's input of a set of workflow instructions. As shown in step 502, flow manager 102 may create and/or edit workflows using a new flow design. For example, a user may interact with user interface 205 to drag-and-drop tasks to create a workflow (e.g., a set of workflow instructions). At step 504, once the instructions are compiled and configured, flow manager 102 generates or maintains an internal mapping to one or more applications or APIs. In some embodiments, flow manager 102 repeats step 504 for multiple tasks using one or more applications or APIs until the last task is executed and the workflow has been completed. At step 506, flow manager may save the set of workflow instructions. For example, flow manager 102 may save the set of workflow instructions as a template workflow. In practice, when flow manager 102 receives a set of workflow instructions (e.g., from user interface 205), flow manager 102 may compare the set of workflow instructions to one or more template workflows. This allows flow manager 102 to quickly and efficiently determine which applications or APIs to use to execute the workflow.

At step 508, flow manager 102 may evaluate the workflow. For example, flow manager 102 may run a test on the workflow generated by the set of workflow instructions to determine whether there are an issues or errors that would result in the workflow not being executed. This may include validations of one or more APIs, confirming that flow manager 102 communicates with the necessary applications or APIs, and/or confirming that flow manager 102 is able to parse each instruction of the set of workflow instructions. In some embodiments, flow manager 102 edits the workflow and/or notifies a user of an error to allow the user to edit the workflow (e.g., via user interface). Flow manager 102 may allow for editing of the workflow and may repeat steps 502 to 508 for the edited workflow. At step 510, flow manager 102 may approve the workflow and publish (e.g., store in a data store) the workflow for execution. Publishing of the workflow allows other users to access, view, edit, and execute the published workflow. For example, the published workflow may be stored within a database (e.g., historical database 106). Once the workflow is published, the workflow may be subsequently executed for use in one or more triggering operations.

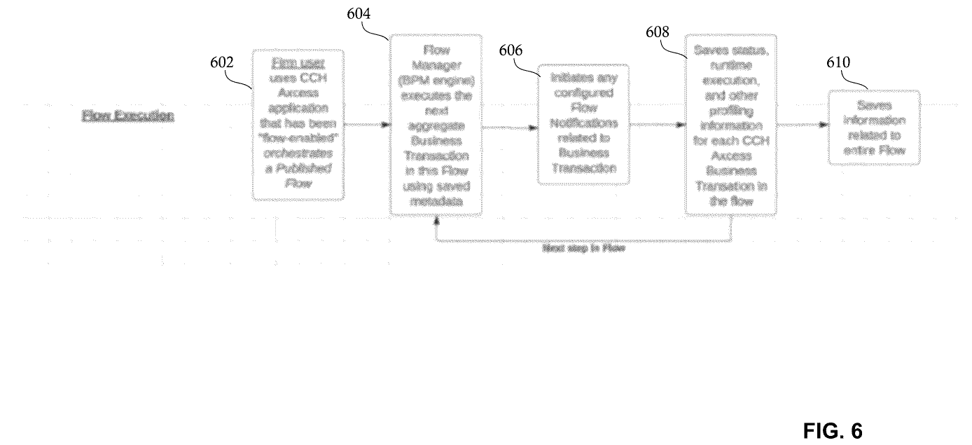

FIG. 6 is a flow diagram showing an exemplary method of using flow manager 102, in accordance with some embodiments. For example, FIG. 6 may show an exemplary method of using flow manager 102 to execute a workflow based on a received set of workflow instructions. At step 602, a user may access a published workflow based on a created workflow or a template workflow (e.g., from historical database 106). At step 604, flow manager 102 may execute one or more tasks (e.g., transactions) associated with the workflow. Flow manager 102 may utilize one or more APIs to execute one or more tasks. In some embodiments, flow manager 102 uses metadata associated with each task. Metadata may include, but is not limited to, input parameters, output parameters, audit logging on/off metadata, staff profile information metadata, client profile information metadata, tax metadata (e.g., return, project, or engagement metadata), notification on/off metadata, etc. At step 608, flow manager 102 may save one or more attributes associated with the executed workflow. For example, flow manager 102 may save status, runtime execution, or other profiling information for each task of the workflow. In some embodiments, flow manager 102 may execute a single task at step 604 and then after step 608, execute the next subsequent task in the workflow. At step 610, flow manager 102 may save execution data associated with execution of the entire workflow (e.g., within execution database 108).

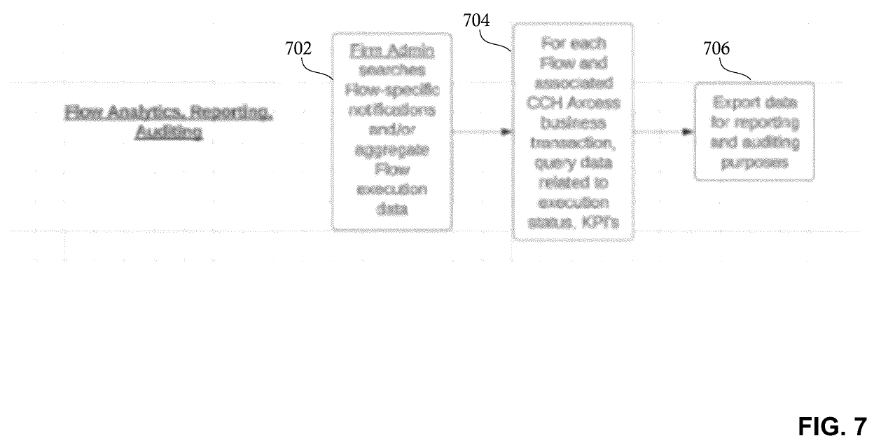

FIG. 7 is a flow diagram showing an exemplary method of using flow manager 102, in accordance with some embodiments. For example, FIG. 7 may show an exemplary method of using flow manager 102 to save and provide analytics or audits associated with executed workflows. At step 702, flow manager 102 may parse system 100 for notifications associated with one or more workflows. For example, flow manager 102 may continuously be searching for notifications or requests to execute a workflow based on a set of workflow instructions. At step 704, for each workflow and task of the workflow, flow manager 102 may query data and metadata to compile execution data (e.g., data associated with execution of one or more tasks or workflows) and/or key performance indicators (KPIs) associated with the workflow. At step 706, flow manager 102 may export the execution data to one or more databases, such as execution database 108. The execution data may be used for auditing purposes to determine the efficiently and accuracy of flow manager 102 in executing workflows. In some embodiments, flow manager 102 utilizes execution data to refine the processes used by flow manager 102 to reduce the number of errors.

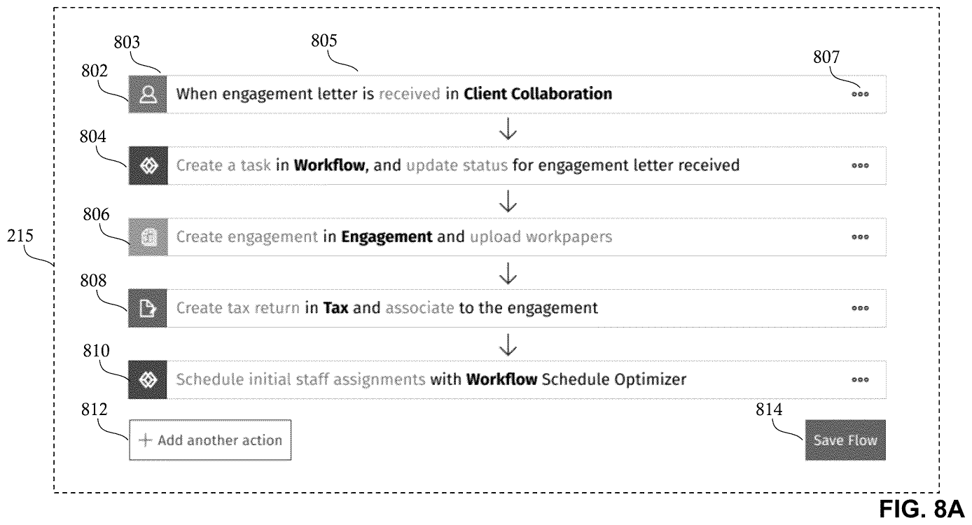

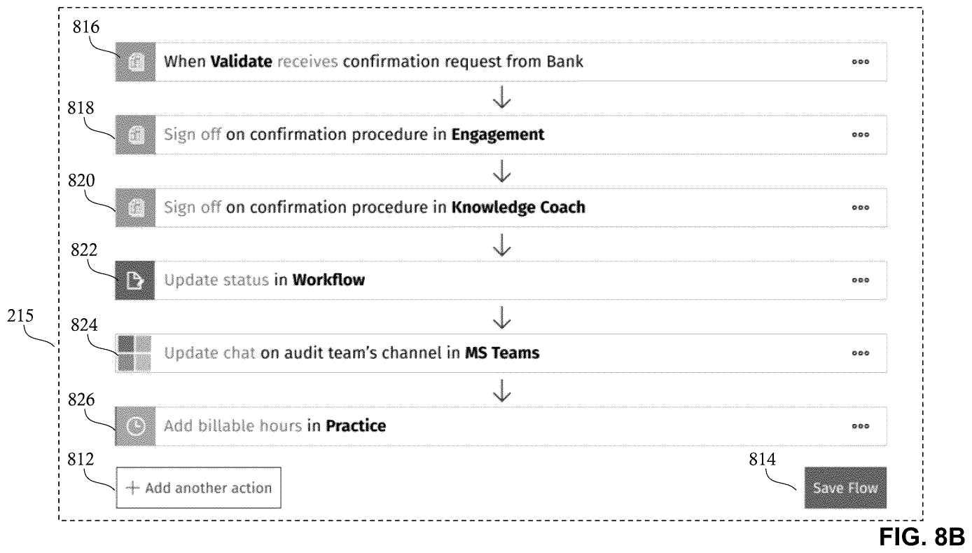

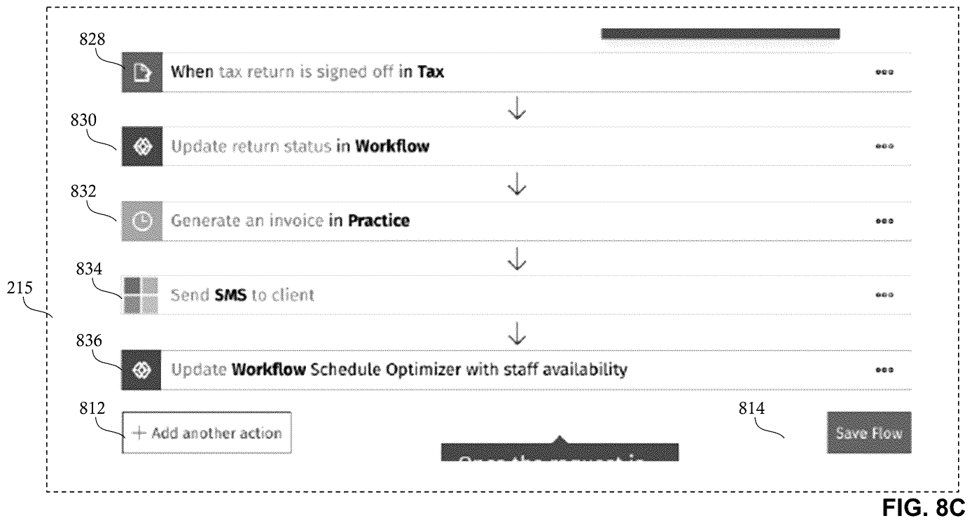

As indicated in FIGS. 8A-8C, flow manager 102 may communicate with user interface 205. User interface 205 may include display screen or display 215. In some embodiments, a user may utilize user interface 205 to interact with screen 215 to generate a set of workflow instructions to compile a workflow.

Referring to FIG. 8A, a set of workflow instructions may include a plurality of tasks 802, 804, 806, 808, and 810. Each task may include identifier 803 and textual data 805. Identifier 803 may provide a visual indication of the type of task. Textual data 805 may include text describing the desired task. Screen 215 may include option 812 and option 814. A user may select option 812 to add another task to the set of workflow instructions. Upon complete of the set of workflow instructions, a user may select option 814 to save the workflow to allow flow manager 102 to execute the workflow.

With continued reference to FIG. 8A, the set of workflow instructions presented in FIG. 8A may be associated with onboarding a new client. A user may generate the set of workflow instructions presented in FIG. 8A by dragging and dropping specific tasks from a repository of tasks (e.g., one or more databases). In some embodiments, a user generates a new task if a task does not exist in the repository of tasks. A user dragging and dropping one or more tasks allows the user to generate a workflow without having to input any code or utilizing a programming software.

In some embodiments, task 802 may be an initial task, that when completed results in flow manager 102 executing tasks 804, 806, 808, and 810. For example, upon receiving an engagement letter at specific location or portal (e.g., Client Collaboration), flow manager 102 may being to execute tasks 804, 806, 808, and 810.

Referring to FIG. 8B, a set of workflow instructions may include a plurality of tasks 816, 818, 820, 822, 824, and 826. The set of workflow instructions presented in FIG. 8B may be associated with an audit. A user may generate the set of workflow instructions presented in FIG. 8B by dragging and dropping specific tasks from a repository of tasks (e.g., one or more databases). In some embodiments, a user generates a new task if a task does not exist in the repository of tasks. A user dragging and dropping one or more tasks allows the user to generate a workflow without having to input any code or utilizing a programming software.

In some embodiments, task 816 may be an initial task, that when completed results in flow manager 102 executing tasks 818, 820, 822, 824, and 826. For example, upon a program or portal (e.g., “Validate”) receiving confirmation request from a third party (e.g., “Bank”), flow manager 102 may being to execute tasks 818, 820, 822, 824, and 826.

Referring to FIG. 8C, a set of workflow instructions may include a plurality of tasks 828, 830, 832, 834, and 836. The set of workflow instructions presented in FIG. 8C may be associated with a tax process. A user may generate the set of workflow instructions presented in FIG. 8C by dragging and dropping specific tasks from a repository of tasks (e.g., one or more databases). In some embodiments, a user generates a new task if a task does not exist in the repository of tasks. A user dragging and dropping one or more tasks allows the user to generate a workflow without having to input any code or utilizing a programming software.

In some embodiments, task 828 may be an initial task, that when completed results in flow manager 102 executed tasks 830, 832, 834, and 836. For example, upon receiving an indication that a tax return has been signed off in a portal or application (e.g., “Tax”), flow manager 102 may being to execute tasks 830, 832, 834, and 836.

FIG. 9 is a flowchart illustrating an exemplary method for no-code and/or low-code workflows, in accordance with some embodiments. At operation 902, flow manager 102 generates a user interface that receives a set of no-code workflow instructions associated with a workflow. At operation 904, flow manager 102 receives, via the user interface, a set of workflow instructions (e.g., no-code instructions) associated with a workflow. In some embodiments, a user utilizes a user interface (e.g., user interface 205) to drag and drop a plurality of tasks of a workflow in a sequential order. In some embodiments, a user may utilize a user interface (e.g., user interface 205) to provide limited code input or modifications to one or more selected tasks. At operation 906, flow manager 102 parses the set of workflow instructions using one or more models to identify and extract a plurality of tasks associated with the workflow. Flow manager 102 may parse the set of workflow instructions to identify a plurality of tasks for the workflow. At operation 908, for each task of the plurality of tasks, flow manager 102 may execute each task using a plurality of application programming interfaces. For example, flow manager 102 may use a plurality of application programming interfaces and exchange metadata between each of the plurality of application programming interfaces to execute the tasks in a sequential order, thereby executing the workflow. In some embodiments, each of the application program interfaces exchanges metadata between each other, the metadata associated with one or more tasks of the plurality of tasks

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 3, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 3.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a computing device comprising at least one processor in communication with a database, the computing device being configured to:
generate a user interface configured to receive a set of workflow instructions associated with a workflow;
receive the set of workflow instructions;
parse the set of workflow instructions using one or more models to identify and extract a plurality of tasks associated with the workflow; and
for each task of the plurality of tasks, execute the task using a plurality of application programming interfaces, wherein each of the application program interfaces exchanges metadata between each other, the metadata associated with one or more tasks of the plurality of tasks.

2. The system of claim 1, wherein the user interface enables a user to input the set of workflow instructions by dragging and dropping the plurality of tasks on a display screen of the user interface.

3. The system of claim 1, wherein a first application programming interface of the plurality of application programming interfaces transmits metadata to a second application programming interface of the plurality of application programming interfaces, the metadata being associated with a task of the workflow.

4. The system of claim 1, wherein the computing device is further configured to:
upon execution of the plurality of tasks, generate execution data associated with the execution of the plurality of tasks.

5. The system of claim 1, wherein the computing device is further configured to:
publish the workflow to allow access to a plurality of users, wherein the workflow is stored within a historical database.

6. The system of claim 1, wherein the computing device is further configured to:
present, on the user interface, the plurality of tasks in an ordered manner.

7. The system of claim 1, wherein the plurality of tasks includes an initial task and completion of the initial tasks results in execution of the workflow.

8. The system of claim 1, wherein the plurality of tasks includes an initial task, a first task, and a second task, and execution of the first task occurs upon completion of the initial task, and execution of the second task occurs upon execution of the first task.

9. The system of claim 1, wherein the plurality of task may be re-ordered based on a user rearranging the plurality of tasks by dragging and dropping one or more tasks of the plurality of tasks.

10. The system of claim 1, wherein the computing device is further configured to:
identify, within a database, one or more template workflows for execution based on the set of workflow instructions, the one or more template workflows being substantially similar to the workflow.

11. A method comprising:
generating a user interface configured to receive a set of workflow instructions associated with a workflow;
receiving the set of workflow instructions;
parsing the set of workflow instructions using one or more models to identify and extract a plurality of tasks associated with the workflow; and
for each task of the plurality of tasks, executing the task using a plurality of application programming interfaces, wherein each of the application program interfaces exchanges metadata between each other, the metadata associated with one or more tasks of the plurality of task.

12. The method of claim 11, wherein a user inputs the set of workflow instructions by dragging and dropping the plurality of tasks on a display screen of the user interface.

13. The method of claim 11, wherein a first application programming interface plurality of application programming interfaces transmits metadata to a second application programming interface of plurality of application programming interfaces, the metadata being associated with a task of the workflow.

14. The method of claim 11 further comprising:
upon execution of the plurality of tasks, generating execution data associated with the execution of the plurality of tasks.

15. The method of claim 11 further comprising:
publishing the workflow to allow access to a plurality of users, wherein the workflow is stored within a historical database.

16. The method of claim 11 further comprising:
presenting, on the user interface, the plurality of tasks in an ordered manner.

17. The method of claim 11, wherein the plurality of tasks includes an initial task and completion of the initial tasks results in execution of the workflow.

18. The method of claim 11, wherein the plurality of tasks includes an initial task, a first task, and a second task, and execution of the first task occurs upon completion of the initial task, and execution of the second task occurs upon execution of the first task.

19. The method of claim 11 further comprising:
identifying, within a database, one or more template workflows for execution based on the set of workflow instructions, the one or more template workflows being substantially similar to the workflow.

20. A non-transitory computer readable medium having instructions stored thereon, wherein the instructions, when executed by at least one processor, cause at least one device to perform operations comprising:
generating a user interface configured to receive a set of workflow instructions associated with a workflow;
receiving the set of workflow instructions;
parsing the set of workflow instructions using one or more models to identify and extract a plurality of tasks associated with the workflow; and
for each task of the plurality of tasks, executing the task using a plurality of application programming interfaces, wherein each of the application program interfaces exchanges metadata between each other, the metadata associated with one or more tasks of the plurality of task.
